(19) United States
(12) Patent Application Publication
(10) Pub. No.: US 2015/0143485 A1
(43) Pub. Date: May 21, 2015

(54) CLOUD SECURITY MANAGEMENT SYSTEM

(71) Applicant: Mineyuki Tamura, Shinagawa-ku (JP)

(72) Inventor: Mineyuki Tamura, Shinagawa-ku (JP)

(21) Appl. No.: 14/404,130

(22) PCT Filed: May 29, 2012
(86) PCT No.: PCT/JP2012/063739

§ 371 Date: Nov. 26, 2014

(51) Int. Cl. G06F 21/12; H04L 29/06

(52) U.S. Cl. CPC G06F 21/121; H04L 63/08
USPC 726/6

(57) ABSTRACT

A purpose of the invention is to accomplish ensuring security and the like when a user program is executed in a cloud environment. The present system comprises a user terminal 2, a public cloud (CL) 3, and an authentication server 1. The CL 3 comprises a server (31) that executes a user program (UP) and a controller 30. The authentication server 1 comprises an authentication control unit 13 and a library 50. The library 50 stores user information (d2), UP information (d3), CL 3 information (d4), server information (d5), and permission information (d1) that manages an association about execution of the UP with the server. The authentication control section 13 performs processes such as a process for generating UP authentication information (F1), a process for generating server authentication information (F2) and a process for determining execution permission with reference to the authentication information (F1, F2) and the permission information (d1) when the UP is executed by the server of the CL 3.

### CROSS REFERENCE TO RELATED APPLICATIONS

This application is entitled to the benefit of and incorporates by reference subject matter disclosed in International Patent Application No. PCT/JP2012/063739 filed on May 29, 2012.

### TECHNICAL FIELD

The present invention relates to an information processing technique such as cloud computing. In particular, the present invention relates to security management upon executing a user program in a cloud environment.

### BACKGROUND ART

As a cloud computing system, there are various public clouds, for example, Windows Azure (registered trademark), Amazon EC2 (registered trademark), and the like. When using a public cloud (the resource/service processing thereof, etc.), an unspecified general user accesses to a server or the like of the public cloud from a user terminal or the like, and performs a user-desired software program processing (Web application processing, batch processing, etc.) with the use of a service processing, data of a storage and the like that are provided by a virtual server. The user can execute a user program in the server (virtual server) of the public cloud on the basis of a contract with the public cloud (the service thereof). A method of the use and a charging system vary depending on various public clouds and the various services thereof.

When executing a user program in a cloud environment such as a public cloud as state above, it is necessary to verify the validity of execution of the user program to prevent spoofing and the like, thereby ensuring security.

As an example of the prior art related to authentication/security management or the like of a program (software), there is Japanese Patent Application Laid-Open Publication No. 2004-46606 and the like. Patent Document 1 and the like disclose a feature for determining whether to permit an execution of a program in a machine (user terminal) by checking a license of the program (software).

### SUMMARY OF THE INVENTION

In an example of the prior art such as the aforementioned Patent Document 1, authority for the execution of a program in a user terminal can be verified, however, it is not a technique corresponding to a cloud environment (a technique for performing authentication and permission, which includes a server (virtual server) or the like that executes, for example, a processing of the user program). Therefore, the example is insufficient for ensuring security in a cloud environment.

In addition, a conventional system which provides a service for executing a user program (the process thereof) in a server (virtual server) in a cloud environment such as a public cloud is insufficient in a means (function) for verifying the validity of execution of the user program in the server. That is, in a conventional public cloud or the like, viewing from a level of a virtual server, one virtual server is configured to be occupied so as to execute only a specific user program; thus, when a plurality of user programs are attempted to be executed in one virtual server, security becomes insufficient (FIG. 8). In other words, in a case where a user program (for example, a program for Web application processing and a program for batch processing) is executed with the use of a server (virtual server) of a public cloud, in order to ensure security, it is necessary to verify the validity of the execution such that whether or not the user program may actually be executed in the server of the public cloud. However, the means (function) is insufficient, and there is room for consideration concerning security ensuring and the like in a cloud environment. More specifically, there are problems (issues) hereinafter illustrated.

For example, in a case where an access from a client to a server or an access among servers occur, in general, an API such as a Web service is called, and in doing so, security is improved by performing authentication or permission based on an ID and a password.

For example, in a public cloud (for example, Windows Azure) of a conventional system, a virtual server (for example, Web Role or Worker Role) is released to users, and a user program can be executed in the virtual server. In such conventional system, when the user program is uploaded (registered) to a cloud environment (server) from a user terminal, authentication of the user program or the like (authentication based on an ID and a password (authority verification, etc.)) is performed. However, after the upload (and authentication), authentication/permission concerning on whether or not the user program may be executed in each server in the cloud environment is not performed, or even if it is performed, it takes a lot of trouble with a process and an operation therefor. That is, effective control/security management in the cloud environment has not been achieved.

In the above-mentioned example of the conventional system, after the upload, in a case where a process is performed after further accessing from a first server that executes the processing of the user program to a second server that has other function and resource in the public cloud, authentication/permission by the above-mentioned ID and password is required for the every access and every type of the second server. For example, the user is required to perform a complicated operation such as writing, in the user program, an ID and a password for every access to the above-mentioned each server; thus a management cost is high.

Furthermore, on the Internet, there are a plurality of programs (user programs) of a plurality of users and a plurality of servers (virtual server) of a plurality of public clouds, and there may be a configuration for executing a plurality of user programs by sharing a server of the public cloud. In this case, it is supposed to control/manage which user program should be executed in a server (shared server) of which public cloud. In this case again, it is considered to be necessary to verify the validity of execution such that whether or not the user program may actually be executed in the server upon accessing to each server in the same manner as described above, thereby ensuring security.

In addition, as a related application by the present inventor, there is PCT/JP2012/0564039 (cloud sharing type resource providing system). This application discloses a feature wherein a provider (resource provider) who provides a shared resource (shared server) to the users by a server of the public cloud is provided between a plurality of users (terminals) and a plurality of public clouds, and a plurality of user programs can be executed in the shared server. Also in the present system, as stated above, a problem concerning security management such that which user program should be executed in a shared server of which public cloud arises.

In view of the foregoing, a main purpose of the present invention is to provide a technique that can solve a problem such as security ensuring in a case where a user program is executed (a plurality of user programs are executed in one virtual server) in the above-mentioned cloud environment (virtual server, etc.). In particular, a main purpose of the present invention is to provide a technique wherein, in a cloud environment including a plurality of users and a plurality of public clouds, by performing authentication/permission (verification, etc. of validity and authority) concerning which user program should be executed in a server (shared server etc.) of which public cloud, security can be ensured and effective control/management is accomplished.

To attain the object suggested above, a typical embodiment within the present invention is a computer system (“cloud security management system”) that executes a user program in a cloud environment such as a public cloud (virtual server, etc.) on the Internet, and in doing so, performs security management, and is characterized by having the following configuration.

In the system of one embodiment, for example, components including a user terminal, a public cloud including a plurality of server and an authentication server are connected by a network. In the public cloud, a target server for executing the aforementioned user program and a controller that performs a control process for managing the server are provided. The aforementioned authentication server comprises an authentication control unit and a storage unit. The aforementioned storage unit stores information containing an ID of the aforementioned user, information containing an ID of the aforementioned user program, information containing an ID of the aforementioned public cloud, information containing an ID of the aforementioned server and permission information for managing an association about an execution of the aforementioned user program with a server of the aforementioned public cloud. The aforementioned authentication control unit comprises: a first processing unit that creates first authentication information for authenticating the aforementioned user program, and includes the aforementioned first authentication information in the aforementioned user program; a second processing unit that creates second authentication information for authenticating a server of the aforementioned public cloud, and provides same to a server of a target public cloud; a third processing unit that sets content of the aforementioned permission information in accordance with an input from the aforementioned user terminal; and a forth processing unit that, when the aforementioned user program is executed in the server of the aforementioned public cloud, in cooperation with the aforementioned controller, refers to the aforementioned first authentication information, the aforementioned second authentication information and the aforementioned permission information, and determines whether the user program is permitted to be executed in the server of the public cloud, and if permitted, executes the user program.

According to a typical embodiment within the present invention, a problem such as security ensuring in a case where a user program is executed (when a plurality of user programs are executed in one virtual server) in the above-mentioned cloud environment (virtual server, etc.) can be solved. In particular, in a cloud environment including a plurality of users and a plurality of public clouds, by performing authentication/permission (verification, etc. of validity and authority) concerning which user program should be executed in a server (shared server etc.) of which public cloud, security can be ensured and effective control/management is accomplished. As a result, a user can easily use a resource such as a public cloud at low prices.

### BRIEF DESCRIPTION OF THE DRAWINGS

FIG. 1 is a diagram illustrating an overall configuration of a system of an embodiment of the present invention (cloud security management system);

FIG. 2 is a diagram illustrating an example of a process sequence among elements in the present system;

FIG. 3 is a diagram illustrating an example of a configuration at the time of registration of a public cloud side in the present system;

FIG. 4 is a diagram illustrating an example of a configuration at the time of registration of a user side in the present system;

FIG. 5 is a diagram illustrating an example of a configuration at the time of execution control and authentication in the present system;

FIG. 6 is a diagram illustrating an example of a configuration of management information in the present system;

FIG. 7 is a diagram illustrating an example of a shared use in the present system;

FIG. 8A is a diagram illustrating a utilization form of a conventional virtual server, and FIG. 8B is a diagram illustrating a utilization form of a virtual server (shared server) in the present system.

### DETAILED DESCRIPTION OF PREFERRED EMBODIMENTS

Hereinafter, an embodiment of the present invention will be described in details on the basis of the drawings. In addition, in all of the drawings for illustrating the embodiment, the same part is denoted by the same reference sign and the repetitive explanation thereof will be omitted.

[General Description, Etc.]

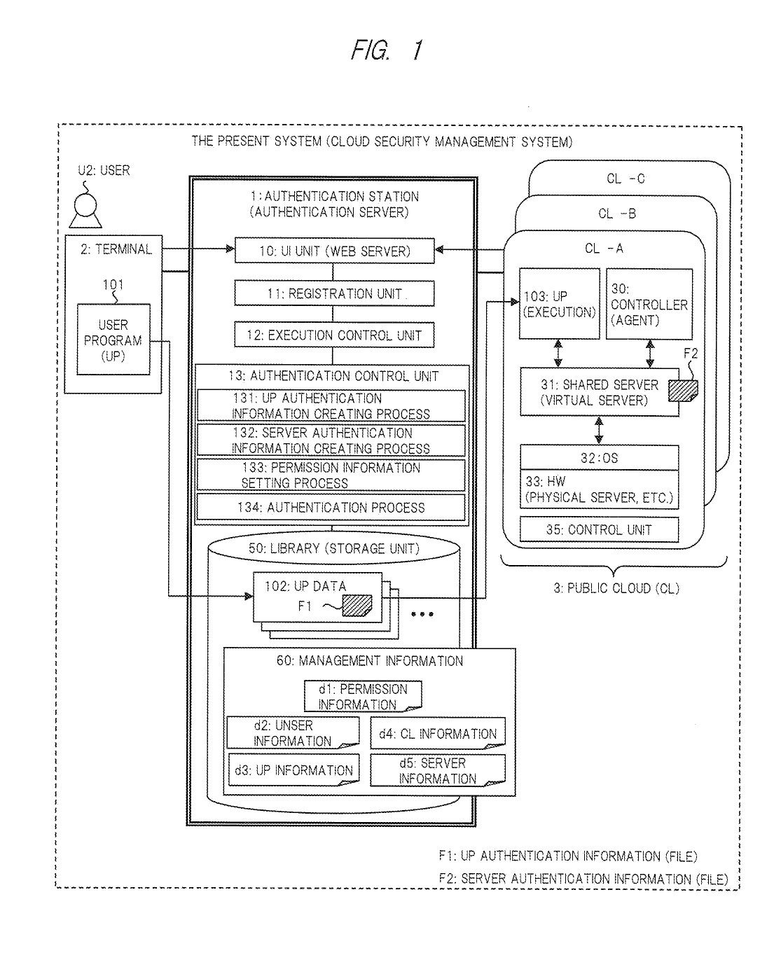

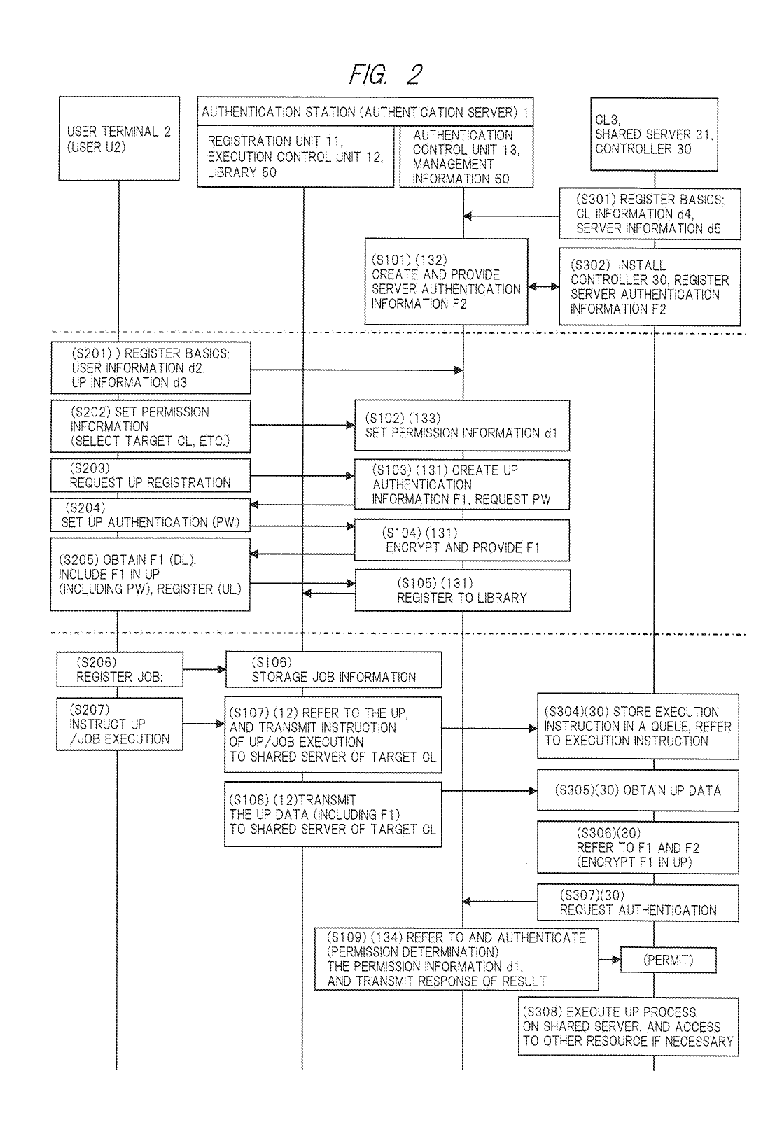

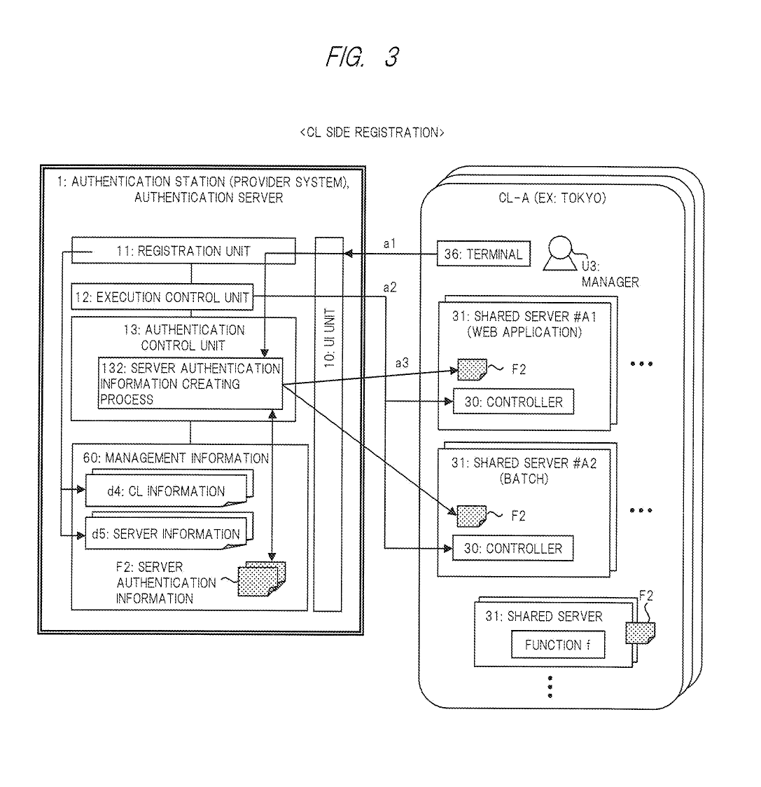

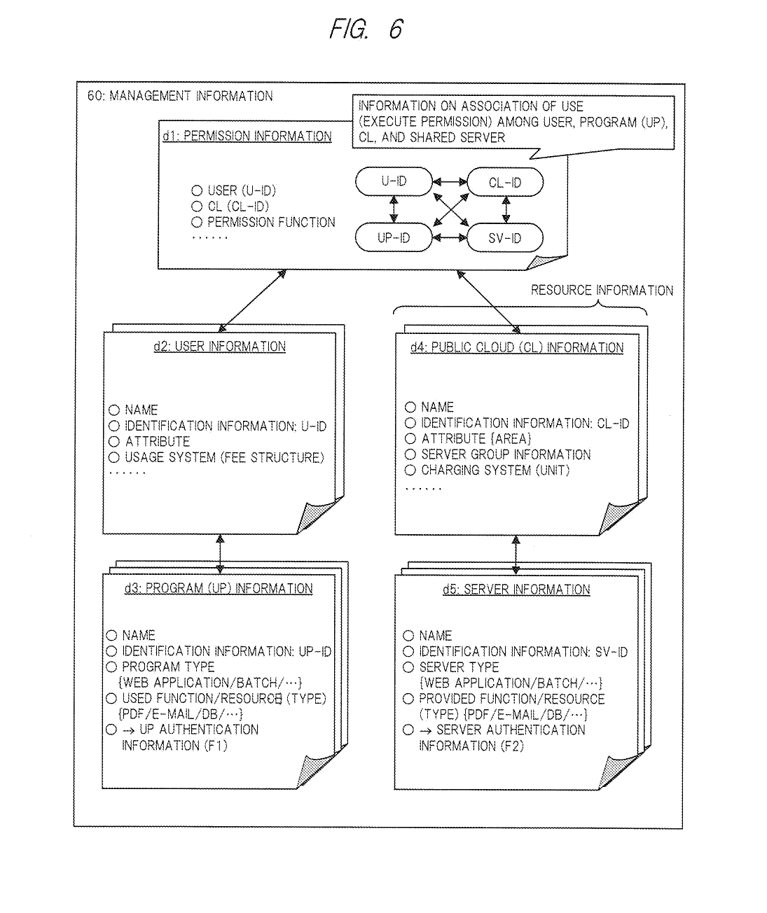

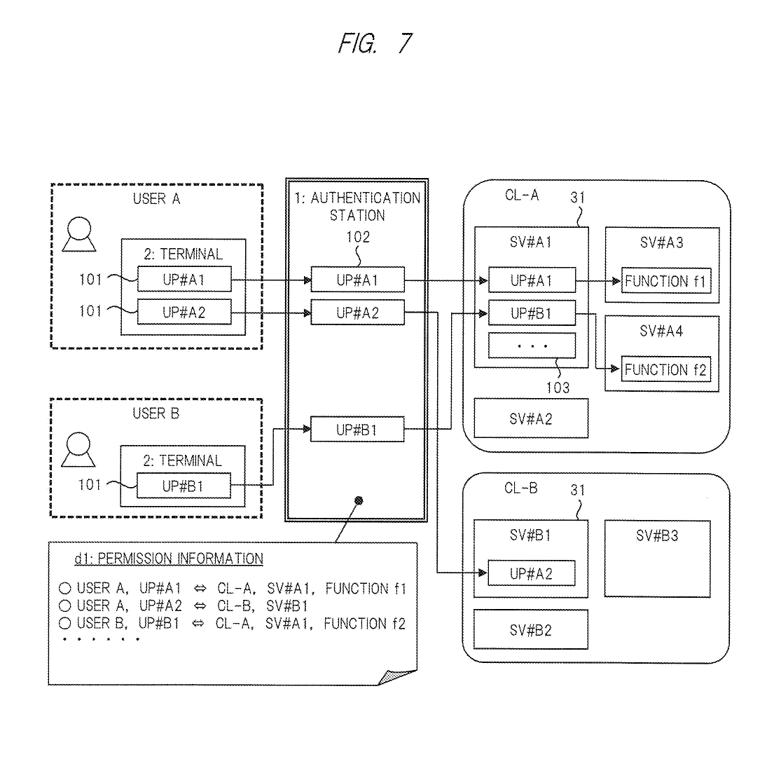

The system according to this embodiment (cloud security management system) performs a process such as FIG. 2 (FIG. 3-FIG. 5) in a system configuration of FIG. 1, manages data information such as FIG. 6, and enables resource sharing in a cloud environment as shown in FIG. 7.

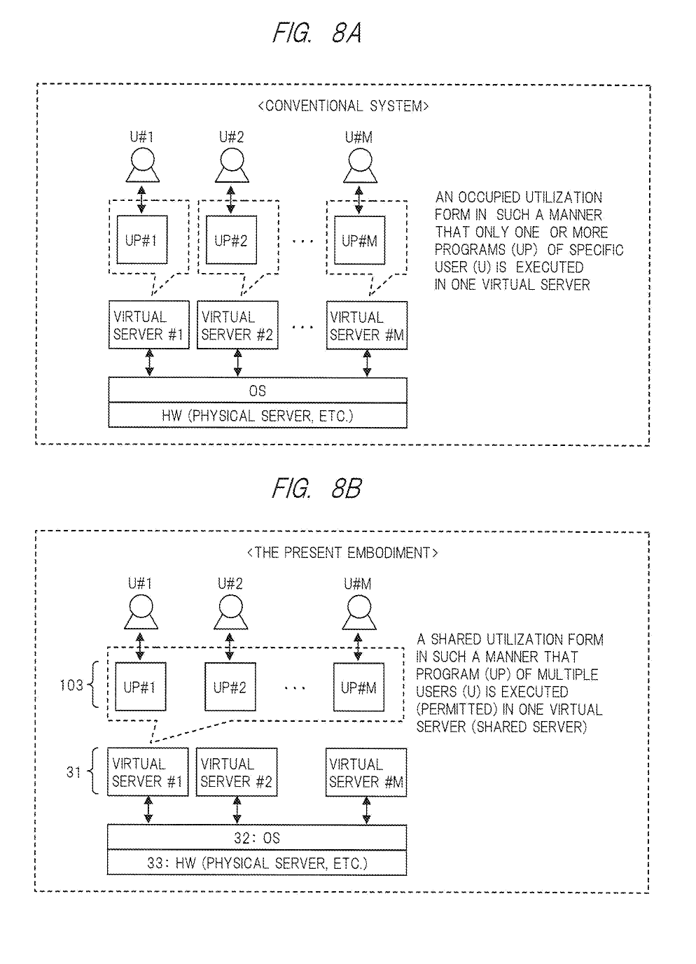

As a premise, FIG. 8A shows utilization form of a virtual server in an example of a conventional public cloud, and FIG. 8B shows a utilization form of a virtual server (shared server) in a system according to this embodiment. In FIG. 8A, on a physical server and an OS thereof, a plurality of virtual servers (#1-#M) are configured. Viewing from a level of a virtual server, one virtual server is configured to be occupied by one to one association so as to execute only one or more programs (UP) of a specific user (U). Meanwhile, in FIG. 8B, in the present system, in a plurality of virtual servers (31) that are configured on a physical server (33) and an OS (32) thereof a public cloud, one virtual server (31) to be a shared server is configured to be used being shared in such a manner that a program (UP) of a plurality of users (U) is executed (permitted). The present system is provided with a function for ensuring security in this utilization form.

As in FIG. 1 and the like, the present system is particularly provided with a system of a provider (authentication station 1) that intervenes between a plurality of users U2 (terminal 2) and a plurality of public clouds 3. The authentication station (authentication server) 1 is provided with a function (authentication control unit 13) for performing a process such as authentication/permission or the like (verification of validity/authority of an execution verification, etc.) upon executing a user program in a server (virtual server) of the public clouds 3. This accomplishes security ensuring/improvement in a cloud environment, and effective control/management of association between a plurality of users U2 and a plurality of public clouds 3. In particular, the present system provides a function for executing a plurality of user programs (shared resource providing service) by sharing a server of the public clouds 3. In this function, in accordance with a request/contract of a user, a request/contract of the public clouds 3, a specific control system/charging system and a state of communication/load, the authentication station (authentication server) 1 controls/manages an association by which a program (UP) of which user U2 should be executed in a virtual server (shared server 31) of which public cloud 3. The present system performs, when a user program (UP) is executed in a server (shared server 31) of the above-mentioned public clouds 3, an authentication process with the use of the authentication control unit 13 of the authentication server 1 (verifies validity/authority of an execution, whether a process of the user program may be executed in the server).

The present system performs a user program (UP) with the use of first authentication information (F1) to prevent spoofing or the like and enhance security, performs authentication of the shared server 31 of the public clouds 3 with the use of the second authentication information (F2) to prevent spoofing or the like and enhance security, and performs authentication (verification) relating to an execution by an association of the user program (UP) with the shared server 31 with the use of the first and second authentication information and permission information (d1), thereby ensuring security.

[(1) System Configuration]

FIG. 1 shows an overall configuration of the system according to this embodiment (cloud security management system). In addition, the present system shown in FIG. 1 includes, as a system to be a basic (premise), a cloud shared resource providing system, and is a form on which a cloud security management system is integrally implemented. In other words, the present system is a configuration which is provided with a cloud shared resource providing function (service) and a cloud security management function (service) that is related to the function.

This whole system comprises an authentication station (authentication server) 1, terminals (user terminal) 2 of a plurality of user U2, and a plurality of various public clouds (abbreviated as CL) 3, and these are connected by a communication network (Internet). FIG. 1 has, as an example of the CL 3, CL-A, B and C. In addition, the CL 3 may include a CL that is operated by a provider of the authentication station 1 and a CL that is operated by other various companies.

The authentication station 1 is a computer system by a provider who intervenes between a plurality of users U2 (terminal 2) and a plurality of CL 3 provides a cloud shared resource providing function and a related cloud security management function, and is configured by including an authentication server.

The authentication station (authentication server) 1 comprises a UI unit 10, a registration unit 11, an execution control unit 12, an authentication control unit 13 and a library 50 (storage unit), and each of these units are connected by, for example, LAN or the like. The authentication control unit 13 comprises a processing unit that performs each process including a UP (user program) authentication information creating process 131, a server authentication information creating process 132, a permission information setting process 133 and an authentication process 134 (authority verification, permission determination process). The library 50 comprises UP (user program) data 102 that is registered from a user terminal 2 and management information 60. Management information 60 includes permission information d1, user information d2, UP (user program) information d3, CL (public cloud) information d4, and server information d5 (FIG. 6). The UP data 102 to be registered contains (includes) a UP authentication information file F1. In addition, the data information of the library 50 is securely managed by the authentication station 1.

Each processing unit (10-13) of the authentication server 1 is implemented by, for example, a software program processing which uses publicly known components such as a processor, a memory, a communication interface, an OS, an input device and an output device that are provided in the authentication server 1 but not shown in the drawings. The library 50 (storage unit) is implemented with the use of, for example, a memory, a storage and a DB that are accessible by the authentication server 1, and an input/output control process thereof.

The authentication station 1 provides, as a cloud shared resource providing function, a resource (shared resource) by a plurality of CLs 3 to a plurality of users U2 with the use of the registration unit 11 and the execution control unit 12, and the like on the basis of a use contract. As this resource, the shared server 31 which is a shared type virtual server to be installed (set) in each CL 3 is included. The user U2 can register a user program 101 (102) in the authentication station 1 (library 50). Furthermore, the shared server 31 can execute a program (UP 103) of the plurality of users U2. In addition, in the present description, the “resource” refers to the whole including all of the CL 3 and shared servers (virtual server) 31 that can be available (candidate) viewing from a user (user program). By a structure in which a plurality of users U2 use a shared resource (shared server 31), the resource can be used at a low cost.

The UI unit 10 is a processing unit that provides a user interface (UI) of the present system to each of the users U2, a provider (manager, etc.) of the CL 3 and a provider of the authentication station 1 (manager, etc.), and is implemented by, for example, a Web server. Each of persons 1, 2 and 3 accesses to a Web page provided by the UI unit 10 of the authentication server 1 from a terminal and logs in, and can perform various settings (registrations), reference to data information, operation relating to instruction input or the like on the screen. In addition, each person registers a dedicated name, an ID or the like as a Web user (aside from an ID, password and the like of authentication information, which will be mentioned later) for the above-mentioned log-in, the authentication server 1 manages the Web user information.

The registration unit 11 performs a process for registering various information (d2, d3) and the UP data 102 to the library 50 by the user U2, and a process for registering various information (d4, d5) to the library 50 by the provider of the CL 3 (or the provider of the authentication station 1).

The execution control unit 12 performs, on the basis of an instruction from the user U2, a control process for executing the UP data 102 registered in the library 50 in a shared server 31 of a target CL 3.

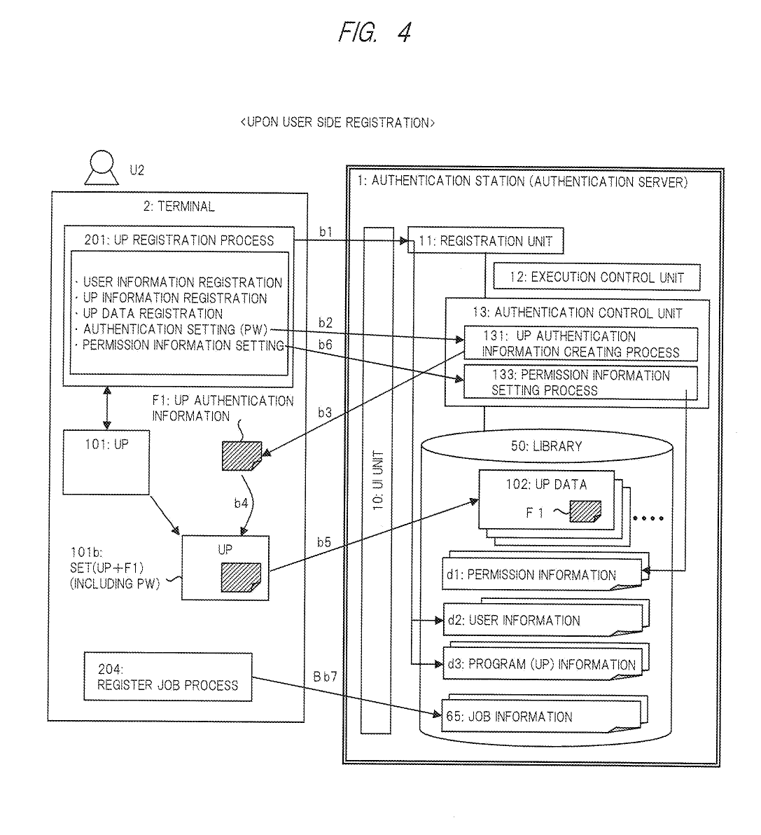

The authentication control unit 13 implements a cloud security management function which is related to the cloud shared resource providing function. In the UP authentication information creating process 131, at the time of registration by the user U2 side (FIG. 3), the authentication control unit 13 creates UP authentication information F1 and performs a process to be provided to the user U2 (user terminal 2). In the server authentication information creating process 132, at the time of registration by the CL 3 side (FIG. 2), the authentication control unit 13 creates server authentication information F2 and performs a process to be provided to the provider of the CL 3 (shared server 31). In the permission information setting process 133, at the time of registration by the user U2 side (FIG. 3), the authentication control unit 13 performs a process for setting permission information d1 or the like. In the authentication process 134, when the UP 102 (103) is attempted to be executed in the shared server 31 (at the time of execution control and authentication (FIG. 4)), the authentication control unit 13 refers to the above-mentioned information F1, F2, d1 or the like, and performs an authentication process (a process for verifying validity/authority of an execution).

(2) The user terminal 2 is a terminal such as a computer system or a PC, which is used by an unspecified general user U2. For example, the user U2 is an enterprise program developer or the like. The user terminal 2 has a user program (UP) 101 that is created/prepared by the user U2. The user terminal 2 is implemented with the use of publicly known components such as a processor, a memory, a communication interface, an OS, an input device and an output device that are not shown in the drawings, and performs a process of an interaction with the authentication station 1 (FIG. 4) or the like by a software program processing.

The UP 101 is data (group of files) of a program (code) for a predetermined process that is executed against a shared server 31 of the target CL 3 (for example, Web application process and a batch processing, etc.). In addition, the UP 101 contains a configuration setting information (configuration) file and the like. In addition, 101, 102 and 103 are corresponding contents.

The user U2 uses the resource (shared server 31) of the CL 3 from the user terminal 2 through the authentication station 1 (the service thereof), and executes the UP 101 (102, 103) on the shared server 31.

(3) The public cloud (CL) 3 comprises a control unit 35 that controls the overall CL 3, a HW (hardware) 33 such as a plurality of physical servers and other publicly known component (storage/DB, network equipment, etc.) that is not shown, and these are connected by a network. The public cloud (CL) 3 comprises an OS 32 that is operated in a HW 33, and one or more shared servers (virtual server) 31 that are operated on the OS 32. The OS 32 includes virtualization software, middleware, and the like. On the shared server 31, one or more user programs (UP) 103 are executed. In addition, a controller 30 operated on the shared server 31 (or on an 0S 33) is provided. The shared server 31 (or a corresponding controller 30) has a server authentication information file F2.

The control unit 35 is a control unit (prior art) which is originally provided in every CL 3, and manages/controls resources and the like including the HW 33 in the CL 3. For example, the control unit 35 controls the activation and termination of the HW 33, and the virtual server (shared server) 31 or the like, and manages a server group comprising a plurality of physical servers and virtual servers. In addition, in general, a plurality of (multiple) physical servers and virtual servers are provided, and there are many cases where those are managed in a unit of a server group, and thus one shared server 31 shown in the drawings may be regarded as a server group (any server may be used in the unit of the server group).

The shared server 31 is a virtual server or a virtual machine which is configured by multiplexing resources on the HW 31 and OS 32 by virtualization software, and is set and released as a shared server. The process of the UP 103 is arbitrarily performed with the use of (with reference to) a resource such as the shared server 31 of the CL 3.

The controller (agent) 30 is a program processing module which performs a control process in cooperation with the authentication server 1, and is placed (installed) together with a corresponding shared server 31. The controller 30 performs a process relating to authentication upon execution of the UP 103 in the shared server 31 in cooperation with the authentication server 1 (authentication control unit 13).

In addition, although not shown in the drawings, the authentication station 1 may comprise a subsystem which monitors a status of the shared server 31 of each CL 3 (an execution status of the UP 103, etc.) on the basis of a cooperation with the controller 30, and performs a charging calculation processing or the like. It is thereby possible to perform charging based on, for example, an execution performance of the UP 103 (for example, batch processing) in the shared server 31.

[(2) Process Sequence]

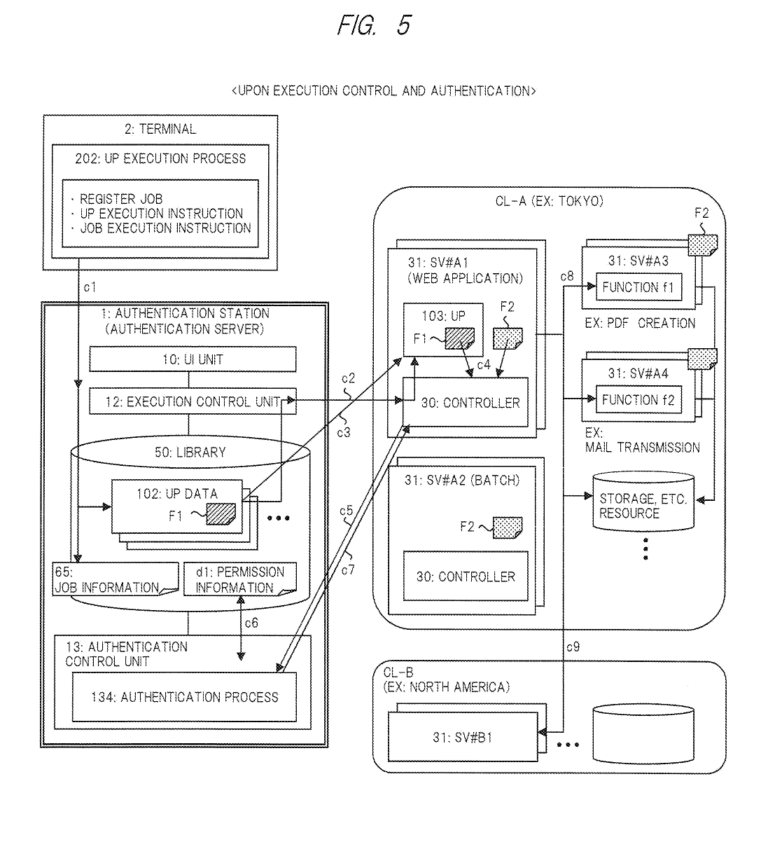

FIG. 2 shows a process sequence among each component (1, 2, 3) in the present system (FIG. 1). S101 and the like show process steps. Broadly speaking, the process steps comprise a process of the CL 3 side registration (FIG. 3), a process of the user U2 side registration (FIG. 4), and a process of execution control/authentication (FIG. 5).

CL 3 Side Registration (FIG. 3):

(S301) First, as a basic registration process of the CL 3 side, on the basis of a contract between CL 3 provider and an authentication station 1, a manager or the like of the CL 3 provider (or instead, a manager or the like of the authentication station 1 provider) registers information concerning the CL 3 and the shared server 31 thereof from a terminal through the UI unit 10 and registration unit 11 of the authentication server 1. The authentication server 1 registers corresponding CL information d4 and server information d5 to the management information 60 (FIG. 6).

(S101) The authentication control unit 13 creates, in the server authentication information creating process 132, server authentication information F2 (including SV-ID, etc.) concerning the above-mentioned CL 3 and shared server 31, and provides (transmits) same to the shared server 31 of the target CL 3 (controller 30).

(S302) The controller 30 is installed in the shared server 31 of the target CL 3, and the shared server 31 (controller 30) receives the above-mentioned server authentication information F2 and stores/manages same.

Upon User U2 Side Registration (FIG. 4):

(S201) As a basic registration (setting) process of the user U2 (user terminal 2) side, on the basis of a contract between the user U2 and the authentication station 1 (application from the user U2), the user U2 (or instead, a manager or the like of the authentication station 1 provider) registers information concerning the user U2 and the UP 101 thereof through the UI unit 10 and registration unit 11 of the authentication server 1. The authentication server 1 registers corresponding user information d2 and UP information d3 to the management information 60 (FIG. 6). In addition, the registration of the UP information d3 may be performed later.

(S202) Further, the user U2 sets the permission information d1 through the UI unit 10 and registration unit 11. For example, the user U2 selects, on a screen, information for setting the permission information d1 (which resource (CL 3, shared server 31, function, etc.) is to be used, or information on a desired performance and fee or the like). In addition, the setting of the permission information d1 may be performed later. For example, upon creation/registration of job information, permission information may be set.

(S102) The permission information setting process 133 of the authentication control unit 13 of the authentication server 1 sets content of corresponding permission information d1 to the management information 60 on the basis of the setting (selection) by the user U2 in S202 (FIG. 6). A manner in which the user U2 directly specifies an association of the UP 101 with the shared server 31 is possible, and an indirect manner, in which, i.e., the authentication station 1 determines a specific association in accordance with a performance and a fee structure desired by the user U2 and the like, is possible.

(S203) The user U2 (user terminal 2) makes an instruction (a request) for registering in advance data (set 101b) of the UP 101 against the registration unit 11 through the UI unit 10. In addition, because of the structure in which the information F1 is required in order to register the UP 101 (102) UP authentication, first, the user U2 requests and obtains (downloads) the F1.

(S103) According to the S203, the authentication server 1 cooperates with the authentication control unit 13, and in the UP authentication information creating process 131, creates UP authentication information F1 (including UP-ID) with the use of relevant user information d2 and UP information d3. Here, for example, the process requests an ID, a password (PW) and the like for encrypting the F1 against the user U2.

(S204) According to the S103, the user U2 sets (designates and inputs) the ID, password (PW) and the like for encrypting the F1.

(S104) The authentication control unit 13 (131) encrypts the UP authentication information F1 with the use of the ID, PW and the like of the step S204, and provides (transmits) the encrypted F1 (file) to the user U2 (user terminal 2).

(S205) Upon obtaining (downloading) the F1 (encrypted state) of the S104, the user U2 (user terminal 2) constitutes a set 101b (associated with PW) by including the F1 in the created/prepared UP 101, and uploads and registers the set 101b to the authentication server 1.

(S105) The authentication server 1(131) receives the set 101b of the step S205, and registers same in the library 50 as the UP data 102.

Upon Execution Control and Authentication (FIG. 5):

(S206) After the above-mentioned registration, the user U2 can arbitrarily register (set) job information concerning the execution of the registered UP 102 from the user terminal 2 through the UI unit 10 of the authentication server 1.

(S106) The execution control unit 12 of the authentication server 1 stores the job information of the step S206 in the library 50 as job information 65.

(S207) The user U2 arbitrarily instructs the execution control unit 12 to execute the registered UP 102 from the user terminal 2 through the UI unit 10. Also, for example, the user U2 can specify the job registered in the S206 and makes a job execution instruction.

(S107) Upon receipt of the execution instruction of the UP (job) of the step S207, the execution control unit 12 of the authentication server 1 refers to a relevant UP data 102, UP information d3, job information 65 and the like in the library 50, and determines the shared server 31 (corresponding controller 30) of the target CL 3 in which the UP (job) is executed, and transmits a UP execution instruction (execution job information) to the shared server 31 of the CL 3.

(S304) The shared server 31 of the target CL 3 (controller 30) receives an instruction/information from the authentication server 1 of S107, stores same in a queue, and successively refers to and processes same.

(S108) Further, the execution control unit 12 of the authentication server 1 transmits the UP data 102 (including the F1) of the S207 to the controller 30 of the shared server 31 of the target CL 3.

(S305) The controller 30 of the shared server 31 of the target CL 3 receives (obtains) the UP data 102 from the authentication server 1 of the step S108.

(S306) The controller 30 of the shared server 31 of the target CL 3 decrypts (decompresses) the UP authentication information F1 contained in the UP data 102 with the use of information such as an ID, a password and the like contained in the obtained UP data 102, and retrieves and refers to the information such as UP-ID contained in the F1.

Further, the same controller 30 refers to the server authentication information F2 that is stored in the shared server 31 in the step S302 in advance. Furthermore, as is the case with the process of the F1, the controller 30 decrypts the F2, and retrieves and refers to the information such as SV-ID contained in the F2.

(S307) The controller 30 of the target shared server 31 transmits an authentication request to the authentication server 1 (authentication control unit 13) for an authentication process (confirm whether or not the UP 102 may be executed in the shared server 31) with the use of the information such as UP-ID, SV-ID and the like obtained from F1 and F2 in the in the step S306.

(S109) Upon receipt of the request of the step S307, the authentication control unit 13 (authority verification process 134) of the authentication server 1 refers to the information such as a UP-ID, SV-ID and the like contained in the request, then refers to relevant permission information d1 in the library 50 (FIG. 6), performs an authentication process, and responsively transmits result information thereof to the shared server 31 of the target CL 3 (controller 30).

(S308) Upon receipt of the result information of the step S109, in a case where the information indicates an execution permission, the controller 30 of the target shared server 31 executes a process of the UP 102 (103) on the shared server 31, and in a case where the information indicates a non-permission, the controller 30 of the target shared server 31 does not execute a process.

In addition, in a case where the UP 103 and the shared server 31 are used for a batch processing, the batch processing is started at a predetermined date and time. Further, if necessary, the process of the UP 103 in the shared server 31 causes an access to other resource (CL 3, shared server 31). In this case, for every the access, an authentication process or the like is performed in the same manner as described above.

[(3) Process upon Registration in CL Side]

FIG. 3 shows an example of a configuration/process at the time of registration in the CL 3 side in the present system. On the basis of a contract between the authentication station 1 provider and the CL 3 provider, the shared server 31 is installed (set) in the target CL 3 in advance. The authentication server 1 (authentication control unit 13) creates/provides to the CL 3 provider (user u3 such as a manager) the server authentication information F2 file that is the authentication information (including SV-ID) of the shared server 31. In particular, the F2 may contain the authentication information (including CL-ID) of a corresponding CL 3. In addition, the structure of the server authentication information F2 is basically same as that of the UP authentication information F1 (FIG. 4, etc.), and thus described in a simplified manner. A plurality of shared servers 31 can be provided in accordance with a type (Web application/batch, etc.), a function (PDF/mail, etc.) and the like, and the server authentication information F2 is stored in each server. Accesses occur as necessary among each shared server 31, and shared servers 31 perform a process in cooperation with one another. As a shared server 31, for example, #A1 is a Web application server, and #A2 is a batch server.

(a1)) The CL 3 provider (U3) accesses to the authentication server 1 from a terminal 36 or the like, and registers the CL information d4 and server information d5 through the processes of the UI unit 10 and registration unit 11 as stated above. (a2) Upon setting up the shared server 31, the authentication control unit 13 provides a program to be the controller 30 to the shared server 31 of the target CL 3 to make the server to install the program. When each shared server 31 is operated, the controller 30 is operated as well. (a3) The server authentication information creating process 132 of the authentication control unit 13 creates server authentication information F2 (encryption by the password of the U3) containing the SV-ID and the like with the use of the CL information d4 and server information d5, and provides same to the shared server 31 of the target CL 3 (controller 30) and have the server to store same.

[(4) Process Upon Registration in User Side]

FIG. 4 shows an example of a configuration/process at the time of registration in the user U2 (terminal 2) side in the present system. The authentication server 1 creates/provides UP authentication information F1 file (including UP-ID) to the user U2 (terminal 2). The F1 may contain the authentication information (including U-ID) of the user U2.

The terminal 2 of the user U2 performs a UP registration process 201 (a process relating to the registration of the UP 101) through a process of the UI unit 10 and registration unit 11 of the authentication server 1 and the like. For example, the terminal 2 performs a UP registration process 201 on a Web page screen that is provided by UI unit 10. The UP registration process 201 comprises the registration of the user information (d2), the registration of the UP information (d3), the registration of the UP data (102), authentication setting (password setting) and the setting of the permission information (d1).

(b1) The user U2 registers the UP information (d3) together with the user information (d2) on the screen as necessary. The user U2 creates/prepares the UP 101, and upon the registration of the UP information (d3), download (obtains) the UP authentication information F1 concerning the UP 101 from the authentication server 1. (b2) In doing so, the user U2 performs an authentication setting (setting of a password for encrypting the UP authentication information F1) for the UP authentication information creating process 131, and (b3) downloads (obtains) the UP authentication information F1 that is encrypted by the UP authentication information creating process 131. (b4) The user U2 constitutes a set 101b by including (attaching) the UP authentication information F1 in the UP 101, and (b5) uploads (registers) same to the library 50 of the authentication server 1 as the UP data 102.

In addition, the above-mentioned operation/process for collecting into and registering the set 101b of a predetermined format may use an existing general tool (for example, software for compressing/encrypting multiple files into one ZIP file), or a dedicated tool may be prepared in the present system. In addition, it is only necessary to use a tool/format according to a required security level.

(b6) Further, upon the registration of each information (d2, d3), the user U2 sets the permission information (d1) concerning the UP 101 (102) through the permission information setting process 133 of the UI unit 10 and authentication control unit 13. The user U2 selects, for example on the screen, for every UP 101, a resource (CL 3, shared server 31 and the function thereof), use system (fee structure) and the like, that are to be used from candidates. The permission information setting process 133 sets content (association, etc.) such as the permission information d1 and user information d2 in accordance with the selection by the user U2. The fee structure is configured to be selectable by presenting, for example, a unit price per second in CPU (processor) as a performance.

(b7) In addition, the user U2 (the register job process 204 of the terminal 2) can arbitrarily register the job information 65. The job information 65 contains information such as a job name, identification information (unique code, etc.), the ID (UP-ID), specification of the permission information d1, and execution date and time of the UP 102 that is used in the job. By registering the job information, when executing the UP 102, the user U2 specifies and executes a job from the UI unit 10, thereby executing the corresponding UP 102 (FIG. 5). In addition, the user U2 can make the execution instruction of the UP 102 directly/individually without registering the job.

In addition, as an example of other configuration, the configuration for registering the set 101b (UP data 102) of the UP 101 and F1 to the library 50 of the authentication server 1 may be in a manner in which spoofing or the like of the user U2 and UP 101 can be prevented, by for example, constituting the set 101b in the authentication server 1 side.

[(5) Process Upon Execution Control/Authentication]

FIG. 5 shows an example of a configuration/process at the time of execution control and authentication by the authentication server 1 and CL 3 in the present system.

(c1) The terminal 2 of the user U2 performs a UP execution process 202 against the UI unit 10 and execution control unit 12 of the authentication server 1. The UP execution process 202 comprises a job registration (same as the 204 of FIG. 4), an individual UP execution instruction, a job execution instruction and the like. For example, the user U2 registers a job and gives an execution instruction of the job. The execution control unit 12 of the authentication server 1 receives an instruction/request from the terminal 2 (UP execution process 202), registers job information 65 to the library 50, and refers to the UP data 102 corresponding to the UP execution instruction and job execution instruction, and controls the execution thereof.

(c2) In accordance with the instruction (c1) from the user U2, the execution control unit 12 cooperates with the controller 30 of the shared server 31 of the target CL 3 and transmits an execution instruction in order to execute relevant UP data 102 in the shared server 31 of the target CL 3. For example, in a case of an instruction by the job information 65, the execution control unit 12 transmits execution job information to the queue that is managed by the CL 3 or the controller 30 from the authentication server 1 and stores same in the queue. (c3) Together with the above-mentioned instruction, the execution control unit 12 retrieves the UP data 102 of the library 50 and transmits same to the target shared server 31.

The shared server 31 (controller 30) operates a process of the target UP 102 (103) on the target shared server 31 in accordance with the instruction (c2) from the execution control unit 12. In doing so, the shared server 31 performs an authentication process in cooperation with the authentication server 1 (authentication control unit 13) in order to verify the validity of execution (authority). For example, the shared server 31 refers to the queue, and if there is job information that should be executed, processes the job information in sequence.

(c4) Before the above-mentioned execution of UP 103 in the shared server 31, the controller 30 refers the server authentication information F2 of the shared server 31, and at the same time, refers to the UP authentication information F1 included in the UP 103. In doing so, the F1 is in an encrypted state, and thus the controller 30 retrieves password information for decrypting contained in the UP 103, and refers to F1 by decrypting (decompressing) with the password. The controller 30 refers to information such as the UP-ID contained in the decrypted F1, and refers to information such as the SV-ID contained in the decrypted F2.

(c5) The controller 30 transmits an authentication request to the authentication server 1 with the use of information such as a UP-ID, SV-ID and the like obtained from the above-mentioned F1 and F2. (c6) The authentication control unit 13 of the authentication server 1 receives a request from the controller 30 in the authentication process 134, and refers to the relevant permission information d1 with the use of the information such as a UP-ID, SV-ID and the like (FIG. 6). Furthermore, the authentication process 134 performs authority verification (permission determination), whether or not the UP 103 (UP-ID) of a relevant user U2 (U-ID) may be executed in a shared server 31 (SV-ID) of a relevant CL 3 (CL-ID). (c7) The authentication server 1 (13) responsively transmits the result information of the authentication process 134 to the controller 30. The controller 30 verifies permission/non-permission on the basis of the result information, and in a case of permission, executes a process of the UP 103 in the shared server 31.

(c8) Furthermore, in the process of the UP 103 in the above-mentioned permitted shared server 31, when an access to other shared server 31 (the function F1 thereof, etc.) in the CL 3 occurs, an authentication process is performed with the use of the UP authentication information F1 and the server authentication information F2 of the accessed shared server 31 in the same manner as described above. (c9) Furthermore, when an access to other CL 3 occurs, an authentication process is performed with the use of the UP authentication information F1 and the server authentication information F2 of the shared server 31 of the accessed CL 3 in the same manner as described above.

As stated above, by an automatic authentication process upon accessing to each shared server 31, a process can be performed after verifying the validity and the authority of association of the UP 103 with the shared server 31, security in the cloud environment can be ensured.

[(6) Management Information]

FIG. 6 shows an example of a configuration of the management information 60 (d1-d5) that is stored and managed in the library 50 (storage unit) of the authentication server 1 in the present system. Each information (d1-d5) is linked/associated with each other as the example shown. Resource information includes the CL information d4 and server information d5.

The permission information d1 is setting information for controlling/managing, as the authentication station 1, an association concerning which UP 101 (102) of which user U2 is permitted to be executed in which shared server 31 (the type and function) of which CL 3, and is referred to for determining (verifying) the permission/non-permission (authority) of an execution upon an authentication process.

The user information d2 is management information of each of a plurality of users U2. The user information d2 comprises information such as a name, identification information (unique code, etc. referred to as U-ID), various attributes (for example, company name, contact information, Web user information, etc.), a use system (fee structure) of the user U2. The use system indicates, for example, a choice that the user U2 has selected from a service item and a fee structure (charging system) presented by the authentication station 1. In addition, an example of the U-ID is represented by “user A”, “U#1” and the like.

The program (UP) information d3 is management information of each of the plurality of UP 101 (102) that is associated with the user U2 (U-ID)(d2). The UP information d3 comprises a name, identification information (unique code, etc. referred to as UP-ID), a program type {for example, for Web application processing/for batch processing}, a used function/resource (type) {for example, PDF/mail/DB, etc.} and the like of the UP 101. In addition, an example of the UP-ID is represented by “UP#A1” or the like. The UP information d3 is associated with the UP authentication information F1 by the UP-ID.

The public cloud (CL) information d4 is management information of each of the plurality of CL 3. The CL information d4 comprises information such as a name, identification information (unique code, etc. referred to as CL-ID), various attributes (for example, provider information, area (location), etc.), server group information, charging system (unit price) of the CL 3. The server group information is management information of a server group (including the shared server 31 group) in the CL 3. The charging system (unit) is information of charging system (unit price) for every the CL 3 (shared server 31). In addition, an example of the CL-ID is represented by “CL-A” or the like.

The server information d5 is management information of each of the plurality of shared server 31, which is associated with the CL 3 (CL-ID)(d4). The server information d5 comprises information such as a name, identification information (unique code, etc. referred to as SV-ID), a server type {for example, for Web application/for batch}, a provided function/resource (type) {for example, PDF/mail/DB, etc.} of the server (shared server 31). In addition, an example of the SV-ID is represented by “SV#A1” or the like.

For example, one or more permission information d1 can be set for every user U2, and is selectively available when multiple d1 s are set. The permission information d1 comprises information of an association of, for example, the U-ID indicating the user U2, the CL-ID indicating the CL 3 that permits a use (access) by the user U2, and a function (for example, PDF, etc.) that permits a use (access) in the CL 3. Alternatively, the permission information d1 contains information of an association (indicating permission) of each ID (U-ID, UP-ID, CL-ID and SV-ID). Therefore, by referring to the permission information d1, it is possible to confirm (determine) which program (UP-ID) of which user U2 (U-ID) may be executed in which shared server 31 (SV-ID) of which CL 3 (CL-ID).

In addition, as how to do the association, various ways are possible: the manner in which all of the UPs 102 of the user U2 is permitted to be executed in all of the shared servers 31 in the CL 3 by associating the U-ID and CL-ID is allowed; and the manner in which, by associating the individual UP-ID and SV-ID, only the combination thereof is permitted to be executed is allowed.

[(7) Authentication Information]

The UP authentication information F1 is information for authentication, that is related to the target UP 101 and the user U2 who is the holder (owner) of the UP. An example of a configuration of the UP authentication information F1 has a format that contains at least the UP-ID, and may further contain information such as the U-ID (indicating the user U2 who has the UP 101). With at least the UP-ID, by the association, the UP information d3 can be referred to, the user information d2 can be referred to, and the permission information d1 can be referred to.

The server authentication information F2 is information for authentication, that is related to the target shared server 31 and the CL 3 that is the holder (owner) of the server. An example of a configuration of the server authentication information F2 has a format that contains at least the SV-ID, and may further contain information such as the CL-ID (indicating the CL 3 that has the shared server 31). With at least the SV-ID, by the association, the server information d5 can be referred to, the CL information d4 can be referred to, and the permission information d1 can be referred to.

In addition, an example of a configuration of the set 101b of FIG. 4 is a set in which the UP authentication information F1 (encrypted state) and the password information thereof are included in the UP 101 (UP data file group). The password information is described in, for example, a configuration setting information file within the UP data file group.

[(8) Example of a Shared Use]

FIG. 7 shows a specific example of sharing a resource in the present system. For example, a first user A has, in the terminal 2, a #A1 and a #A2 that are two UPs 101. For example, the #A1 is a program for processing a Web application, and the #A2 is a program for processing a batch. A second user B has, in the terminal 2, a #B1 that is one UP 101. For example, the #B1 is a program for processing a Web application. Each UP 101 is registered to the library 50 of the authentication station 1, and correspondingly, the permission information d1 and the like are set as the example shown. For example, the process of the UP#A1 of the user A is permitted to be executed in a SV#A1 (for processing a Web application) that is the first shared server 31 of a CL-A (for example, Tokyo), the process of the UP#A2 is permitted to be executed in a SV#B1 (for processing batch) that is the first shared server 31 of a CL-B (for example, North America). The process of a UP#B1 of the user B is permitted to be executed in the SV#A1 (for processing a Web application) that is the first shared server 31 of a CL-A. Further, in the process of the UP#A1, a function f1 (for example, PDF generation process) is used (permitted), and an access to a SV#A3 that is a shared server 31 having the function f1 from the SV#A1 is permitted. Similarly, in the process of the UP#B1, a function f2 (for example, mail transmission process) is used (permitted), and an access to a SV# A4 that is a shared server 31 having the function f2 from the SV#A1 is permitted.

In this manner, each user U2 can execute the UP 101 with the use of a desired resource (CL 3, shared server 31), and at the same time, the aforementioned authentication is performed upon processing in each shared server 31; thus, security is ensured.

Further, each CL 3 (A, B, C) is different from each other in a location (area) and in a distance from the user U2 (terminal 2), and a performance and a function differ from each other. A charging system (use unit price) or the like differs for every various CL 3, shared server 31, and function (f1, etc.). By setting total service item/fee structure and providing same to the user U2 in accordance with a combination of those use in the authentication station 1, the user U2 can easily use a cloud environment at low prices. For example, in a screen of the UI unit 10, a unit price per performance, a fee per function and the like are presented, and the user U2 can select from them and make a use contract. The user U2 can specify and use a specific CL 3 or the like, and can also specify performance requirement or the like and can use independently from a specific CL 3.

Also, for example, the batch processing of the UP#A2 in the SV#B1 is executed at a predetermined date and time, and thus, by monitoring the status (operating time, etc.) of the batch processing by the controller 30, a charging calculation processing corresponding to the monitoring information can be performed in the authentication station 1.

[Effects, etc.]

As described above, according to this embodiment, by the verification using the authentication information (F1, F2) and permission information d1 of both of the user (UP 101) and the CL 3 (shared server 31), authentication/permission (verification of execution validity/verification of an authority, etc.) that is related to that a program (UP) of which user U2 is executed in a shared server 31 or the like of which CL 3 is performed in a cloud environment particularly including a plurality of users U2 and a plurality of CL 3; thus, security can be ensured and effective control/management is accomplished in a case a plurality of user programs are executed by one virtual server, which results in enabling the user U2 to easily use a resource such as the CL 3 at low prices, and easily implementing a Web application processing, a batch processing and the like at low prices.

In particular, in the user U2 side, security can be ensured, for which it is only necessary to include the UP authentication information F1 in the UP 101 and upload (register) same to the authentication server 1 side and not necessary to consider subsequent processes (a control, an authentication, etc. in the authentication server 1 side and each CL 3 side). It is not necessary for the user U2 to write, in consideration of the security, in the codes in the UP 101, an ID, a password, and the like for every access to the aforementioned each resource, and thus a work load becomes small and the codes can also be simplified.

Furthermore, in particular, a provider who provides the authentication station (authentication server) 1 installs (sets) the shared server 31 in each CL 3. This allows a service for performing a control of an association about an execution and the authentication (security management) thereof in a plurality of users U2 (UP 101) and a plurality of CL 3 (shared server 31). In accordance with a requirement and a contract of the user U2, a requirement and a contract of the CL 3, a particular charging system and control system, a communication status and the like, an effective and flexible control of an association can be implemented, and the security thereof can be ensured and improved as well.

While the invention made by the present inventor has been specifically described above, the present invention is not limited to the aforementioned embodiment, and it goes without saying that various modifications can be made without departing from the scope thereof.

In the foregoing, the invention made by the inventor of the present invention has been concretely described based on the embodiments. However, it is needless to say that the present invention is not limited to the foregoing embodiments and various modifications and alterations can be made within the scope of the present invention.

The present invention is applicable to a public cloud or the like.

While the present invention has been illustrated and described with respect to a particular embodiment thereof, it should be appreciated by those of ordinary skill in the art that various modifications to this invention may be made without departing from the spirit and scope of the present.

What is claimed is:

1. A cloud security management system in which components including a user terminal, a public cloud including a plurality of servers, and an authentication server are connected by a network, wherein a target server for executing a user program and a processing controller for performing a control related to the execution are provided in the public cloud, the authentication server comprises an authentication control unit and a storage unit, the storage unit stores information containing an ID of the user, information containing an ID of the user program, information containing an ID of the public cloud, information containing an ID of the server, and permission information for managing an association about an execution of the user program with a server of the public cloud, and the authentication control unit comprises: a first processing unit that creates first authentication information for authenticating the user program, and includes the first authentication information in the user program; a second processing unit that creates second authentication information for authenticating a server of the public cloud, and provides same to the server of the public cloud; a third processing unit that sets content of the permission information in accordance with an input from the user terminal; and a forth processing unit that, when the user program is executed in the server of the public cloud, in cooperation with the controller, refers to the first authentication information, the second authentication information and the permission information, and determines whether the user program is permitted to be executed in the server of the public cloud, and if permitted, executes the program.

2. The cloud security management system according to claim 1, wherein the first processing unit of the authentication control unit of the authentication server encrypts the first authentication information with the use of first password information specified from the user terminal, includes the encrypted first authentication information and the first password information in the user program, and when the user program is executed in the server of the public cloud, the controller refers to the ID of the server contained in the second authentication information stored in the server, refers to the first authentication information and first password information included in the user program, decrypts the first authentication information with the use of first password information, refers to the ID of the program contained in the first authentication information, and transmits an authentication request containing the ID of the server and the ID of the program to the authentication server, and a forth processing unit of the authentication control unit of the authentication server refers to relevant permission information with the use of the ID of the server and the ID of the program contained in the authentication request, and determines the execute permission.

3. The cloud security management system according to claim 1, wherein a plurality of first servers that are targets for executing the user program and a plurality of second servers that provides various functions for processing the user program are provided in the public cloud, the second authentication information is stored in each server, and the forth processing unit of the authentication server refers to the first authentication information corresponding to the user program, the second authentication information corresponding to the accessed second server and the permission information and determines a use permission of a function of the second server in cooperation with the controller for every access from the first server to the second server.

4. The cloud security management system according to claim 1, comprising: a plurality of user terminals; and a plurality of public clouds, wherein one or more shared servers that become candidates for sharing and executing the a plurality of user programs and the controller that performs a control process for managing the shared servers are provided in the public cloud, an association about an execution of the user program with the shared servers of the public cloud is set in the permission information.

5. The cloud security management system according to claim 1, wherein the authentication server comprises a registration unit and an execution control unit, the registration unit performs a process for storing data of the user program in the storage unit on the basis of an instruction from the user terminal, the execution control unit performs, on the basis of the instruction from the user terminal, in cooperation with the controller, a control process for executing the data of the user program registered in the storage unit in a server of a target public cloud, the first processing unit of the authentication control unit creates first authentication information for authenticating the user program, includes the first authentication information in the user program, and registers same to the storage unit.

6. The cloud security management system according to claim 1, wherein the authentication server comprises a user interface unit that provides a screen to the user terminal, the user can directly specify a target server of the public cloud for executing the user program and a function on the screen by the user interface unit, and the third processing unit sets the content of the permission information in accordance with the specification.

7. The cloud security management system according to claim 1, wherein the authentication server comprises a user interface unit that provides a screen to the user terminal, the user can indirectly specify a target server of the public cloud for executing the user program and a function on the screen by the user interface unit in a selection form of a performance or a fee structure, and in accordance with the specification, the third processing unit determines an association of a target server of the public cloud for executing the user program with the function, and sets the content of the permission information.
